(19) United States
(12) Patent Application Publication
(10) Pub. No.: US 2023/0132498 A1
(43) Pub. Date: May 4, 2023

(54) ALUMINUM-LITHIUM ALLOY WITH LOW DENSITY, HIGH STRENGTH, AND HIGH ELASTIC MODULUS AND ITS PRODUCTION METHOD

(71) Applicant: Beijing Institute of Technology, Beijing (CN)

(72) Inventors: Junsheng WANG, Beijing (CN); Xinghai YANG, Beijing (CN); Guangyuan TIAN, Beijing (CN); Chengpeng XUE, Beijing (CN); Shuo WANG, Beijing (CN); Yuxuan ZHANG, Beijing (CN)

(73) Assignee: Beijing Institute of Technology, Beijing (CN)

(21) Appl. No.: 17/978,242

(22) Filed: Nov. 1, 2022

(30) Foreign Application Priority Data
Nov. 1, 2021 (CN) 202111285168.8

(51) Int. Cl. C22C 21/16; C22C 1/02; C22F 1/057

(52) U.S. Cl. CPC C22C 21/16; C22C 1/026; C22F 1/057

(57) ABSTRACT

An aluminum-lithium alloy with low density, high strength, and high elastic modulus and its production method are provided. A chemical composition of the aluminum-lithium alloy with low density, high strength, and high elastic modulus by weight is: Cu 1.5-4.5 wt %, Li 2.4-3.8 wt %, Mg 0.5-2.0 wt %, Zn 0.5-1.0 wt %, Ag 0.3-0.8 wt %, Er 0.05-0.3 wt %, Zr 0.05-0.25 wt %, Fe≤0.08 wt %, Si≤0.05 wt %, and the balance is Al and inevitable impurities. The production method includes: preparing raw materials, drying, adjusting pressure of an electromagnetic-induction furnace, melting in a vacuum induction furnace, power adjustment, casting, heat treatment, cooling. Degassing and slag removals are avoided, and defects of aluminum-lithium alloy during production are reduced.

### CROSS REFERENCE TO THE RELATED APPLICATIONS

This application is based upon and claims priority to Chinese Patent Application No: 202111285168.8, filed on Nov. 1, 2021, the entire contents of which are incorporated herein by reference.

### TECHNICAL FIELD

The present application belongs to a technical field of a new material of aluminum-lithium alloy and its production, and relates to an aluminum-lithium alloy with low density, high strength and high elastic modulus and its production method.

### BACKGROUND

Demands for light-weight and high-strength metal materials in the field of manufacturing aerospace structural parts are increasingly growing currently. Adding Li, which is the lightest metal element in nature, into aluminum alloy will further improve the specific strength of the traditional aluminum alloy.

However, in regard to the load-bearing structural parts, only increasing strength of the alloy cannot effectively increase the lifetime of structural parts. Fractures caused by small deformations also have a negative impact on the lifetime of the structural parts. Therefore, while pursuing the strength improvement for the current new generation of aluminum-lithium alloys, it is also necessary to make sure that the alloy has a high elastic modulus to increase the deformation resistance, and thus improve the lifetime of the structural parts.

A method of producing aluminum-lithium alloy with high elastic modulus mainly involves designing of Li content of the alloy and its heat treatment process. It is shown by the current research that elastic modulus may be increased by 6 times, while Li content in the aluminum-lithium alloy increased by 1 wt %. Besides, the addition of Li content will also increase the challenges of preparing aluminum-lithium alloys, because the activity of Li element is very high, and excess Li will be oxidized immediately to form Li₂O in the air. Besides, Li₂O also absorbs moisture easily in the air to form LiOH. The adverse factors such as oxides and H elements will be introduced into the preparation of aluminum-lithium alloys, and the metallurgical defects such as pores, white spots, and hydrogen embrittlement may exist in the aluminum-lithium alloy as prepared, which is harmful to the preparation of alloy with high Li content.

Besides, the subsequent heat treatment process of aluminum-lithium alloy ingot also has a great influence on its elastic modulus. The as-cast aluminum-lithium alloy with high Li content comprises large-sized aluminum-lithium phases distributed in the grain boundaries. A proper solid-solution heat treatment is necessary to make these coarse Li-containing second phases re-dissolve into the matrix and form an over-saturated solid solution, and then form nano-scale Li-containing precipitates in the over-saturated solid solution by aging heat treatment, to ensure aluminum-lithium alloy ingots after heat treatment have a high elastic modulus.

The research has found that degassing with a refining agent under the protection of a covering agent in a resistance furnace is used to refine by most of the existing processes of casting aluminum-lithium alloy, which is a complicated process, and lithium thereof is easily oxidized during preparation.

For example, a Chinese patent CN108570580A disclosed an aluminum-magnesium-lithium alloy with a high lithium content and preparation method thereof, the alloy being prepared by removing Cu from AA8090 alloy. Shanghai Jiaotong University disclosed a method of preparing aluminum-lithium alloy, with Mg 1-4 wt %, Li 2.5-3 wt %, Zr 0.15-0.2 wt %, Sc 0.1-0.15 wt %, the melt being protected using a mixture of lithium chloride and lithium fluoride with a weight ratio of 3:1, and the casting was under the protection of argon. However, the preparation process is relatively complicated, and the molten metal is easily in contact with air during slag removal and casting, and Li is easily oxidized in the presence of high Li content.

A Chinese patent CN108570580A disclosed a scandium-containing aluminum-lithium alloy and preparation method thereof, the alloy being prepared by removing Cu from AA2099 alloy, with Cu 0.8-1.8 wt %, Mg 0.2-0.7 wt %, Li 1.6-1.99 wt %, and Zr 0.1-0.25 wt %. This alloy has a strength of 400-450 MPa and an elastic modulus of 77-78 GPa, which is much lower than 80 GPa, after the two-stage solid solution and one-stage aging heat treatment.

A Chinese patent CN108570579A disclosed a magnesium-containing aluminum-lithium alloy and a preparation method thereof, with Cu 0.9-1.9 wt %, Mg 0.2-0.7 wt %, Li 1.6-1.99 wt %, Zr 0.1-0.25 wt %, Sc 0.05-0.35 wt %. Although the protection of covering agent and argon can effectively avoid the oxidation of Li element, the process is complicated, the covering agent will be largely consumed in the industrial application, and the price of Sc is $3460/kg. The price of Er in the present application is $26.4/kg, the process is simple, so obviously, the rare earth element Er selected by the present application is more beneficial to large-scale industrial production.

### SUMMARY

The technical problems solved by the present application are that rare earth elements of aluminum-lithium alloy with low density, high strength and high elastic modulus in the prior art are expensive and unsuitable for industrial production; using the covering agent and argon for protection in the preparation process is complicated, and brings side effects; and the elastic modulus is low, no more than 80 GPa; lithium element is easily oxidized during preparation, which results in a high lithium loss, and elastic modulus cannot be improved effectively; the large-sized aluminum-lithium phase cannot be fully dissolved in the matrix by the solid solution process.

In order to solve the above technical problems, the present application provides following technical solutions:

An aluminum-lithium alloy with low density, high strength, and high elastic modulus, wherein a chemical composition thereof by weight is: Cu 1.5-4.5%, Li 2.4-3.8%, Mg 0.5-2.0%, Zn 0.5-1.0%, Ag 0.3-0.8%, Er 0.05-0.3%, Zr 0.05-0.25%, Fe≤0.08%, Si≤0.05%, the balance being Al and inevitable impurities.

Preferably, an as-cast structure of the aluminum-lithium alloy with low density, high strength, and high elastic modulus is a face-centered cubic aluminum matrix and coarse intermetallic compounds of Al₂CuMg, Al₆CuLi₃, Al₇Cu₄Li, AlLi at grain boundaries. A heat treatment state structure thereof is the face-centered cubic aluminum matrix and nano-sized precipitates of Al₂CuLi, Al₃Li, Al₂CuMg that are uniformly distributed, and the intermetallic compounds at the grain boundaries are significantly smaller than the as-cast structure in size.

Preferably, the aluminum-lithium alloy has: a density of 2.47-2.69 g/cm³, a tensile strength of 230-350 MPa, an elongation of 2.0-8.0%, an as-cast elastic modulus of 77-83 GPa, and a heat-treatment-state elastic modulus of 80-86 GPa.

Preferably, a preparation method comprises the following steps:

S1, preparing raw materials

weighing pure Al, pure Ag, pure Li, Al—Cu master alloy, Al—Mg master alloy, Al—Zn master alloy, Al—Er master alloy and Al—Zr master alloy as raw materials based on the chemical composition by weight of the aluminum-lithium alloy;

S2, drying

pre-heating the pure Al, the pure Ag, the Al—Cu master alloy, the Al—Mg master alloy, the Al—Zn master alloy, the Al—Er master alloy and the Al—Zr masteralloy weighed in S1 and a crucible for 0.5-2 h at 200-220° C. in S1;

S3, adjusting operating parameters of electromagnetic-induction furnace

placing the raw materials pre-heated in S2 into the pre-heated crucible, and then placing into the electromagnetic-induction furnace, adjusting the pressure in the electromagnetic-induction furnace to 5-10 kPa before melting, and then adding argon until the pressure in the furnace reaches 100-110 kPa, repeating the above steps 2-4 times, and finally keeping the pressure in the furnace at 105-115 kPa;

S4, melting in a vacuum induction furnace

increasing the temperature step by step by increasing the power output to melt the raw materials of S3 until the aluminum-lithium alloy raw materials are completely melted;

S5, power adjustment

adjusting the power of the electromagnetic-induction furnace with the program to apply electromagnetic stirring apply electromagnetic stirring between 10% and 100% for 5-10 min after melting in S4, and repeating S3;

S6, casting

adjusting the temperature in the crucible after S5 and keeping the temperature; injecting alloy melt in the crucible into a copper mold from the bottom of the crucible, and immediately applying a pressure of 150-250 kPa to the copper mold for 1-3 min to obtain an aluminum-lithium alloy ingot;

S7, heat treatment

placing the aluminum-lithium alloy ingot obtained by vacuum melting and casting in S6 into an inert gas protected furnace, and performing a three step solution heat treatment, and then quenching the ingot in water immediately;

performing an one-stage ageing treatment to the ingot subjected to the three step solution heat treatment in the inert gas protected furnace;

S8, cooling

taking out the ingot subjected to heat treatment in S7 and cooling in air to obtain the aluminum-lithium alloy with low density, high strength, and high elastic modulus.

Preferably, the crucible in S3 is a steel crucible specially coated with boron nitride.

Preferably, the process of increasing the temperature step by step to smelt in S4 comprises:

first increasing the temperature of the alloy in the crucible to 300-350° C. within 2-5 min, then increasing the temperature of the crucible to 450-500° C. within 2-3 min, then increasing to 650-700° C. within 3-5 min, and finally increasing to 750-800° C. within 2-3 min.

Preferably, the alloy melt in S6 is injected into the copper mold within 5-10 s.

Preferably, the three step solution heat treatment in S7 comprises:

keeping the temperature at 430-450° C. for 4-6 h, 470-490° C. for 4-6 h and 500-520° C. for 4-6 h, respectively;

quenching the ingot in water immediately after the temperature keeping, with a heating rate of 1-2° C./min.

Preferably, the one-stage ageing treatment in S7 comprises: keeping the temperature for 6-24 h in a temperature range of 160-200° C.

Preferably, the inert gas in S7 is argon. the pressure in the furnace is adjusted to less than 1 kPa before argon is introduced into the furnace, and the pressure in the furnace is adjusted to 100-105 kPa by introducing argon, and the above steps are repeated for 1-3 times.

The above-mentioned technical solutions provided by the examples of the present application have at least the following beneficial effects:

Hereinabove, a method of vacuum electromagnetic-induction heating and inert gas protection is used in the present application to smelt aluminum-lithium alloy with high lithium content, which avoids lithium oxidation, repeated usage of the covering agent for protection and other dangers in the atmospheric environment.

A process of electromagnetic-induction melting is optimized by the present application. The temperature is slowly increased step by step in the heating process, which can accurately control the melting temperature. The molten metal is electromagnetically stirred by controlling the power of the vacuum furnace to apply electromagnetic stirring at a certain frequency, and vacuum-pumping and argon blowing are performed repeatedly to ensure effective removal of harmful impurity elements in aluminum-lithium alloys and avoid excessive burning of alloy elements.

Injecting molten metal from the bottom of the crucible can effectively remove the enriched oxide inclusions on upper surface of the crucible; at the same time, by pressurizing the melt after casting, defects, for example holes and shrinkage inside the aluminum-lithium alloy ingot can be significantly reduced, which can significantly improve the elastic modulus of as-cast alloy.

The present application may further improve elastic modulus of the alloy relative to the traditional as-cast aluminum-lithium alloy ingot by means of the three step solution heat treatment and the one-stage aging treatment, and finally an aluminum-lithium alloy ingot with high elastic modulus which is not available in the prior art is obtained.

The price of Er added to the aluminum-lithium alloy ingot with high elastic modulus in the present application is $26.4/kg, which is two orders of magnitude lower than that of the traditional Sc, which is $3460/kg, and the process is also simple, which is beneficial to large-scale industrial production.

The as-cast structure of the aluminum-lithium alloy with low density, high strength and high elastic modulus in the present application is a face-centered cubic aluminum matrix and an intermetallic compound of Al₂CuMg, Al₆CuLi₃, Al₇Cu₄Li, AlLi that has coarse grains at grain boundaries, a heat treatment state structure thereof is the face-centered cubic aluminum matrix and nano-sized precipitates of Al₂CuLi, Al₃Li, Al₂CuMg that are uniformly distributed, and the intermetallic compound at the grain boundaries are significantly smaller than the as-cast structure in size.

The aluminum-lithium alloy with low density, high strength and high elastic modulus in the present application has: a density of 2.47-2.69 g/cm³, a tensile strength of 230-350 MPa, an elongation of 2.0-8.0%, an as-cast elastic modulus of 77-83 GPa, and a heat-treatment-state elastic modulus of 80-86 GPa.

In conclusion, the present application relates to the aluminum-lithium alloy with Cu 1.5-4.5 wt % and Li 2.4-3.8 wt %, which is much higher than that of all previously reported contents of Cu and Li. The vacuum melting and inert gas protection are used, in order to eliminate the harmful elements such as H, Na, K and the impurities in the aluminum lithium alloy, and the alloy elements in the cast ingot are controlled within a specified range. The process of producing alloy ingot is simpler than that under the protection of covering agent. Combined with a specific heat treatment process, the elastic modulus of the cast aluminum-lithium alloy can be significantly improved, which is the basis for the subsequent preparation and processing of high-elastic-modulus deformable parts of the aluminum-lithium alloy, and can be widely applied in the aerospace field.

### BRIEF DESCRIPTION OF THE DRAWINGS

In order to illustrate the technical solutions in the embodiments of the present application more clearly, the following briefly introduces the accompanying drawings used in the description of the embodiments. Obviously, the accompanying drawings in the following description are only some embodiments of the present application. For those of ordinary skill in the art, other drawings can also be obtained from these drawings without creative effort.

FIGS. 1A-1B are metallographic structure diagrams of the aluminum-lithium alloy with low density, high strength and high elastic modulus according to Embodiment 1 of the present application, wherein: FIG. 1A is as-cast structure, and FIG. 1B is heat treatment structure;

FIGS. 2A-2B are metallographic structure diagrams of the aluminum-lithium alloy with low density, high strength and high elastic modulus of Embodiment 2 of the present application, wherein: FIG. 2A is as-cast structure, and FIG. 2B is heat treatment structure;

FIGS. 3A-3B are metallographic structure diagrams of the aluminum-lithium alloy with low density, high strength and high elastic modulus according to Embodiment 3 of the present application, wherein: FIG. 3A is as-cast structure, and FIG. 3B is heat treatment structure;

FIGS. 4A-4B are metallographic structure diagrams of the aluminum-lithium alloy with low density, high strength and high elastic modulus according to Embodiment 4 of the present application, wherein: FIG. 4A is as-cast structure, and FIG. 4B is heat treatment structure.

### DETAILED DESCRIPTION OF THE EMBODIMENTS

In order to make the technical problems, technical solutions and advantages to be solved by the present application, the following will be described in details with reference to the accompanying drawings and specific embodiments.

### Embodiment 1

A chemical composition of the aluminum-lithium alloy with low density, high strength, and high elastic modulus by weight is: Cu 4.40 wt %, Li 2.40 wt %, Mg 0.61 wt %, Zn 0.75 wt %, Ag 0.68 wt %. %, Er 0.18 wt %, Zr 0.13 wt %, Fe 0.07 wt %, Si 0.02 wt %, and the balance is Al and inevitable impurities.

A method for preparing the aluminum-lithium alloy with low density, high strength and high elastic modulus comprises the following steps:

S1, preparing raw materials

weighing pure Al, pure Ag, pure Li, Al—Cu master alloy, Al—Mg master alloy, Al—Zn master alloy, Al—Er master alloy and Al—Zr master alloy as raw materials; wherein the purity of pure Al, pure Ag and pure Li is ≥99.9%;

S2, drying

pre-heating the pure Al, the pure Ag, the Al—Cu master alloy, the Al—Mg master alloy, the Al—Zn master alloy, the Al—Er master alloy and the Al—Zr master alloy weighed in S1 and a crucible for 1 h at 200° C.;

S3, adjusting pressure of an electromagnetic-induction furnace

placing the raw materials pre-heated in S2 into the pre-heated crucible, and then placing the pre-heated crucible into the electromagnetic-induction furnace, adjusting the pressure in the electromagnetic-induction furnace to 5 kPa before melting, and then adding argon until the pressure in the furnace reaches 110 kPa, repeating the above steps 3 times, and finally keeping the pressure in the furnace at 110 kPa;

S4, melting in a vacuum induction furnace

increasing the temperature step by step by heating power adjustment to smelt the raw materials of S3 until the aluminum-lithium alloy raw materials are completely melted; wherein the process of increasing the temperature step by step to smelt comprises: first increasing the temperature of the alloy in the crucible to 350° C. in 3 min, then increasing the temperature in the crucible to 500° C. in 3 min, then increasing the temperature in the crucible to 700° C. in 5 min, and finally increasing the temperature in the crucible to 780° C. in 2 min, until the alloy in the crucible is completely melted;

S5, power adjustment

adjusting the power of the electromagnetic-induction furnace with a program to apply electromagnetic stirring between 10% and 100% for 5 min after melting in S4, and repeating S3;

S6, casting

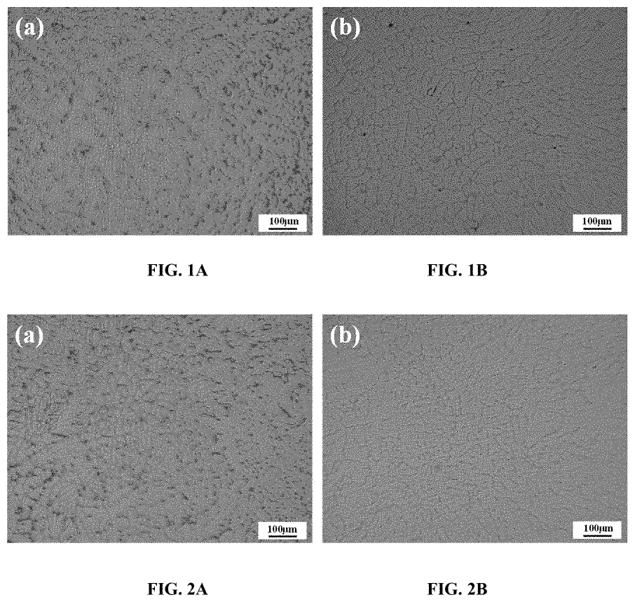

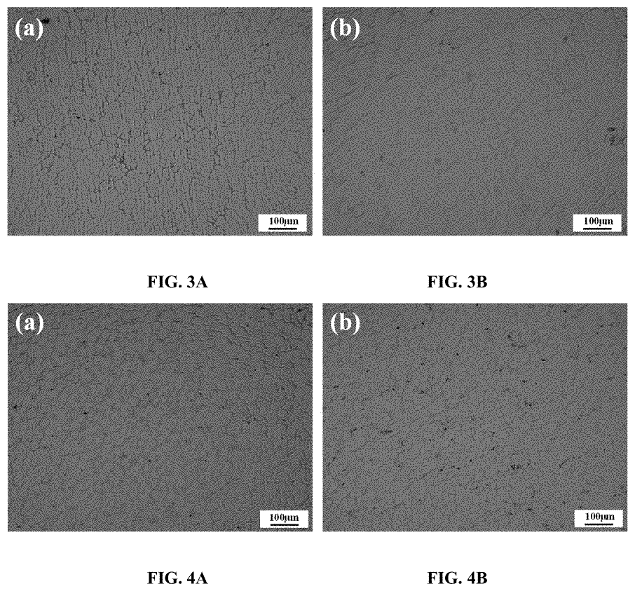

adjusting the temperature in the crucible to 730° C. after S5, and keeping the temperature for 25 min; then injecting the alloy melt in the crucible into the copper mold from the bottom of the crucible with 10 s; then immediately applying a pressure of 180 kPa to the copper mold for 1 min, to obtain an aluminum-lithium alloy ingot; its metallographic structure is shown in FIG. 1A, and the elastic modulus of the as-cast aluminum-lithium alloy is tested by the pulse excitation method;

S7, heat treatment

placing the aluminum-lithium alloy ingot obtained by a vacuum melting and casting in S6 into an inert gas protected furnace, and performing a three step solution heat treatment, and then quenching the ingot in water immediately; wherein, the three step solution heat treatment comprises: keeping the temperature at 450° C. for 4 h, 490° C. for 4 h, and 520° C. for 6 h, respectively. The ingot is quenched in water immediately after temperature keeping, with a heating rate of 1° C./min;

performing an one-stage ageing treatment in a temperature range at 180° C. for 9 h to the ingot subjected to a solid solution in an inert gas protected furnace;

S8, cooling

taking out the ingot subjected to heat treatment in S7 and cooling in air to obtain the aluminum-lithium alloy with low density, high strength, and high elastic modulus; the metallographic structure of the heat-treated alloy is shown in FIG. 1B, and the elastic modulus of the heat-treated aluminum-lithium alloy is measured by pulse excitation method.

Hereinabove, the inert gas used is argon.

Hereinabove, the crucible in S3 is a steel crucible specially coated with a boron nitride.

In the above-mentioned S7, the pressure in the furnace is adjusted to less than 1 kPa before argon is introduced into the furnace, and the pressure in the furnace is adjusted to 105 kPa by introducing argon, and the above steps are repeated for 3 times.

The aluminum-lithium alloy with low density, high strength and high elastic modulus has: density of 2.65 g/cm³, tensile strength of 231 MPa, elongation of 7.2%, as-cast elastic modulus of 77.6 GPa, and the heat treatment elastic modulus of 81.6 GPa.

### Embodiment 2

A chemical composition of the aluminum-lithium alloy with low density, high strength, and high elastic modulus by weight is: Cu 3.26 wt %, Li 2.44 wt %, Mg 0.54 wt %, Zn 0.75 wt %, Ag 0.61 wt %, Er 0.17 wt %, Zr 0.13 wt %, Fe 0.06 wt %, Si 0.02 wt %, and the balance is Al and inevitable impurities.

A method for preparing the aluminum-lithium alloy with low density, high strength and high elastic modulus comprises the following steps:

S1, preparing raw materials

weighing pure Al, pure Ag, pure Li, Al—Cu master alloy, Al—Mg master alloy, Al—Zn master alloy, Al—Er master alloy and Al—Zr master alloy as raw materials; wherein the purity of pure Al, pure Ag and pure Li is ≥99.9%;

S2, drying

pre-heating the pure Al, the pure Ag, the Al—Cu master alloy, the Al—Mg master alloy, the Al—Zn master alloy, the Al—Er master alloy and the Al—Zr master alloy weighed in S1 and a crucible for 1 h at 200° C.;

S3, adjusting pressure of an electromagnetic-induction furnace

placing the pre-heated raw materials in S2 into the pre-heated crucible, and placing the pre-heated crucible into the electromagnetic-induction furnace, adjusting the pressure in the electromagnetic-induction furnace to 7 kPa before melting, and then adding argon until the pressure in the furnace reaches 110 kPa, repeating the above steps 4 times, and finally keeping the pressure in the furnace at 110 kPa;

S4, melting in a vacuum induction furnace

increasing the temperature step by step by heating power adjustment to smelt the raw materials of S3 until the aluminum-lithium alloy raw materials are completely melted; wherein, the process of increasing the temperature step by step to smelt comprises: first increasing the temperature of the alloy in the crucible to 350° C. in 4 min, then increasing the temperature in the crucible to 480° C. in 2 min, then increasing the temperature in the crucible to 680° C. in 4 min, and finally increasing the temperature in the crucible to 750° C. in 2 min, until the alloy in the crucible is completely melted;

S5, power adjustment

adjusting the power of the electromagnetic-induction furnace by a program to apply electromagnetic stirring between 10% and 100% for 7 min after melting in S4, and repeating S3;

S6, casting

adjusting the temperature in the crucible to 740° C. after S5, and keeping the temperature for 30 min; then injecting the alloy melt in the crucible into the copper mold from the bottom of the crucible, with an injection time of 8 s; then immediately applying a pressure of 200 kPa to the copper mold for 2 min, to obtain an aluminum-lithium alloy ingot; the metallographic structure is shown in FIG. 1A, and the elastic modulus of the as-cast aluminum-lithium alloy is tested by the pulse excitation method;

S7, heat treatment

placing the aluminum-lithium alloy ingot obtained by a vacuum melting and casting in S6 into an inert gas protected furnace, and performing a three step solution heat treatment, and then quenching the ingot in water immediately; wherein, the three step solution heat treatment comprises: keeping the temperature at 430° C. for 4 h, 490° C. for 4 h, and 515° C. for 6 h, respectively. The ingot is quenched in water immediately after temperature keeping, with a heating rate of 1° C./min;

performing an one-stage ageing treatment in a temperature range of 180° C. for 16 h to the ingot subjected to a solid solution in an inert gas protected furnace;

S8, cooling

taking out the ingot subjected to the heat treatment in S7 and cooling in air to obtain the aluminum-lithium alloy with low density, high strength, and high elastic modulus; the metallographic structure of the heat-treated alloy is shown in FIG. 1B, and the elastic modulus of the heat-treated aluminum-lithium alloy is measured by pulse excitation method.

Hereinabove, the inert gas used is argon.

Hereinabove, the crucible is a steel crucible specially coated with boron nitride.

In the above-mentioned S7, the pressure in the furnace is adjusted to less than 1 kPa before argon is introduced into the furnace, and the pressure in the furnace is adjusted to 110 kPa by introducing argon and the above steps are repeated for 3 times.

The aluminum-lithium alloy with low density, high strength and high elastic modulus has: density of 2.62 g/cm³, tensile strength of 240 MPa, elongation of 3.1%, as-cast elastic modulus of 77.6 GPa, and the heat treatment elastic modulus of 81.7 GPa.

### Embodiment 3

A chemical composition of the aluminum-lithium alloy with low density, high strength, and high elastic modulus by weight is: Cu 1.61 wt %, Li 2.82 wt %, Mg 1.37 wt %, Zn 0.60 wt %, Ag 0.58 wt %, Er 0.19 wt %, Zr 0.23 wt %, Fe 0.05 wt %, Si 0.02 wt %, and the balance is Al and inevitable impurities.

A method for preparing an aluminum-lithium alloy with low density, high strength and high elastic modulus comprises the following steps:

S1, preparing raw materials

weighing pure Al, pure Ag, pure Li, Al—Cu master alloy, Al—Mg master alloy, Al—Zn master alloy, Al—Er master alloy and Al—Zr master alloy as raw materials; wherein the purity of pure Al, pure Ag and pure Li is ≥99.9%;

S2, drying

pre-heating the pure Al, the pure Ag, the Al—Cu master alloy, the Al—Mg master alloy, the Al—Zn master alloy, the Al—Er master alloy and the Al—Zr master alloy weighed in S1 and a crucible for 1 h at 200° C.;

S3, adjusting pressure of an electromagnetic-induction furnace

placing the pre-heated raw materials in S2 into the pre-heated crucible, and placing the pre-heated crucible into the electromagnetic-induction furnace, adjusting the pressure in the electromagnetic-induction furnace to 5 kPa before melting, and then adding argon until the pressure in the furnace reaches 110 kPa, repeating the above steps 4 times, and finally keeping the pressure in the furnace at 110 kPa;

S4, melting in a vacuum induction furnace

increasing the temperature step by step by heating power adjustment to smelt the raw materials of S3 until the aluminum-lithium alloy raw materials are completely melted; wherein, a process of increasing the temperature step by step to smelt comprises: first increasing the temperature of the alloy in the crucible to 350° C. in 3 min, then increasing the temperature in the crucible to 480° C. in 2 min, then increasing the temperature in the crucible to 680° C. in 3 min, and finally increasing the temperature in the crucible to 750° C. in 2 min, until the alloy in the crucible is completely melted;

S5, power adjustment

adjusting the power of the electromagnetic-induction furnace by a program to apply electromagnetic stirring between 10% and 100% for 5 min after melting in S4, and repeating S3;

S6, casting

adjusting the temperature in the crucible to 730° C. after S5, and keeping the temperature for 25 min; then injecting the alloy melt in the crucible into the copper mold from the bottom of the crucible, with an injection time of 10 s; then immediately applying a pressure of 150 kPa to the copper mold for 2 min, to obtain an aluminum-lithium alloy ingot; the metallographic structure is shown in FIG. 1A, and the elastic modulus of the as-cast aluminum-lithium alloy is tested by the pulse excitation method;

S7, heat treatment

placing the aluminum-lithium alloy ingot obtained by a vacuum melting and casting in S6 into an inert gas protected furnace, and performing a three step solution heat treatment, and then quenching the ingot in water immediately; wherein, the three step solution heat treatment comprises: keeping the temperature at 450° C. for 4 h, 490° C. for 4 h, and 520° C. for 6 h, respectively. The ingot is quenched in water immediately after temperature keeping, with a heating rate of 1° C./min;

performing an one-stage ageing treatment in a temperature range of 180° C. for 14 h to the ingot subjected to a solid solution in an inert gas protected furnace;

S8, cooling

taking out the ingot subjected to the heat treatment in S7 and cooling in air to obtain the aluminum-lithium alloy with low density, high strength, and high elastic modulus; the metallographic structure of the heat-treated alloy is shown in FIG. 1B, and the elastic modulus of the heat-treated aluminum-lithium alloy is measured by pulse excitation method.

Hereinabove, the inert gas used is argon.

Hereinabove, the crucible in S3 is a steel crucible specially coated with a boron nitride.

In the above-mentioned S7, the pressure in the furnace is adjusted to less than 1 kPa before argon is introduced into the furnace, and the pressure in the furnace is adjusted to 105 kPa by introducing argon, and the above steps are repeated for 3 times.

The aluminum-lithium alloy with low density, high strength and high elastic modulus has: density of 2.53 g/cm³, tensile strength of 229 MPa, elongation of 2.8%, as-cast elastic modulus of 77.2 GPa, and the heat treatment elastic modulus of 80.4 GPa.

### Embodiment 4

A chemical composition of the aluminum-lithium alloy with low density, high strength, and high elasticity-modulus by weight is: Cu 2.53 wt %, Li 3.46 wt %, Mg 1.53 wt %, Zn 0.73 wt %, Ag 0.64 wt %, Er 0.20 wt %, Zr 0.20 wt %, Fe 0.07 wt %, Si 0.02 wt %, and the balance is Al and inevitable impurities.

A method for preparing an aluminum-lithium alloy with low density, high strength and high elastic modulus comprises the following steps:

S1, preparing raw materials

weighing pure Al, pure Ag, pure Li, Al—Cu master alloy, Al—Mg master alloy, Al—Zn master alloy, Al—Er master alloy and Al—Zr master alloy as raw materials; wherein the purity of pure Al, pure Ag and pure Li is ≥99.9%;

S2, drying

pre-heating the pure Al, the pure Ag, the Al—Cu master alloy, the Al—Mg master alloy, the Al—Zn master alloy, the Al—Er master alloy and the Al—Zr master alloy weighed in S1 and a crucible for 2 h at 200° C.;

S3, adjusting pressure of an electromagnetic-induction furnace

placing the pre-heated raw materials in S2 into the pre-heated crucible, and placing the pre-heated crucible into the electromagnetic-induction furnace, adjusting the pressure in the electromagnetic-induction furnace to 5 kPa before melting, and then adding argon until the pressure in the furnace reaches 105 kPa, repeating the above steps 4 times, and finally keeping the pressure in the furnace at 105 kPa;

S4, melting in a vacuum induction furnace

increasing the temperature step by step by heating power adjustment to smelt the raw materials of S3 until the aluminum-lithium alloy raw materials are completely melted; wherein, a process of increasing the temperature step by step to smelt comprises: first increasing the temperature of the alloy in the crucible to 300° C. in 2 min, then increasing the temperature in the crucible to 450° C. in 2 min, then increasing the temperature in the crucible to 650° C. in 3 min, and finally increasing the temperature in the crucible to 760° C. in 2 min, until the alloy in the crucible is completely melted;

S5, power adjustment

adjusting the power of the electromagnetic-induction furnace by a program to apply electromagnetic stirring between 10% and 100% for 5 min after melting in S4, and repeating S3;

S6, casting

adjusting the temperature in the crucible to reach 730° C. after S5, and keeping the temperature for 20 min; then injecting an alloy melt in the crucible into a copper mold from the bottom of the crucible, with an injection time of 10 s; then immediately applying a pressure of 200 kPa to the copper mold for 2 min to obtain an aluminum-lithium alloy ingot; wherein metallographic structure is shown in FIG. 4A, and the elastic modulus of the as-cast aluminum-lithium alloy is tested by the pulse excitation method;

S7, heat treatment

placing the aluminum-lithium alloy ingot obtained by a vacuum melting and casting in S6 into an inert gas protected furnace, and performing a three step solution heat treatment, and then quenching the ingot in water immediately; wherein, the three step solution heat treatment comprises: keeping the temperature at 430° C. for 6 h, 490° C. for 4 h and 515° C. for 6 h, respectively; then quenching the ingot in water immediately after temperature keeping, with a heating rate of 1° C./min;

performing an one-stage ageing treatment in a temperature range of 180° C. for 14 h to the ingot subjected to a solid solution in an inert gas protected furnace;

S8, cooling

taking out the ingot subjected to the heat treatment in S7 and cooling in air to obtain the aluminum-lithium alloy with low density, high strength, and high elastic modulus; the metallographic structure of the heat-treated alloy is shown in FIG. 4B, and the elastic modulus of the heat-treated aluminum-lithium alloy is measured by pulse excitation method.

Hereinabove, the inert gas used is argon.

Hereinabove, the crucible is a steel crucible specially coated with boron nitride.

In the above-mentioned S7, the pressure in the furnace is adjusted to less than 1 kPa before argon is introduced into the furnace, and the pressure in the furnace is adjusted to 105 kPa by introducing argon, and the above steps are repeated for 3 times.

The aluminum-lithium alloy with low density, high strength and high elastic modulus has: density of 2.52 g/cm³, tensile strength of 255 MPa, elongation of 2.5%, as-cast elastic modulus of 81.6 GPa, and the heat treatment elastic modulus of 85.4 GPa.

### Embodiment 5

A chemical composition of the aluminum-lithium alloy with low density, high strength, and high elasticity-modulus by weight is: Cu 3.80 wt %, Li 3.00 wt %, Mg 1.61 wt %, Zn 0.85 wt %, Ag 0.52 wt %, Er 0.15 wt %, Zr 0.09 wt %, Fe 0.07 wt %, Si 0.03 wt %, and the balance is Al and inevitable impurities.

A method for preparing the aluminum-lithium alloy with low density, high strength and high elastic modulus comprises the following steps:

S1, preparing raw materials

weighing pure Al, pure Ag, pure Li, Al—Cu master alloy, Al—Mg master alloy, Al—Zn master alloy, Al—Er master alloy and Al—Zr master alloy as raw materials; wherein the purity of pure Al, pure Ag and pure Li is ≥99.9%;

S2, drying

pre-heating the pure Al, the pure Ag, the Al—Cu master alloy, the Al—Mg master alloy, the Al—Zn master alloy, the Al—Er master alloy and the Al—Zr master alloy weighed in S1 and a crucible for 0.8 h at 215° C.;

S3, adjusting pressure of an electromagnetic-induction furnace

placing the pre-heated raw materials in S2 into the pre-heated crucible, and placing the pre-heated crucible into the electromagnetic-induction furnace, adjusting the pressure in the electromagnetic-induction furnace to 6 kPa before melting, and then adding argon until the pressure in the furnace reaches 102 kPa, repeating the above steps 4 times, and finally keeping the pressure in the furnace at 109 kPa;

S4, melting in a vacuum induction furnace

increasing the temperature step by step by heating power adjustment to smelt the raw materials of S3 until the aluminum-lithium alloy raw materials are completely melted; wherein the process of increasing the temperature step by step to smelt comprises: first increasing the temperature of the alloy in the crucible to 310° C. in 2 min, then increasing the temperature in the crucible to 460° C. in 4 min, then increasing the temperature in the crucible to 660° C. in 4 min, and finally increasing the temperature in the crucible to 770° C. in 2 min, until the alloy in the crucible is completely melted;

S5, power adjustment

adjusting the power of the electromagnetic-induction furnace by a program to apply electromagnetic stirring between 10% and 100% for 8 min after melting in S4, and repeating S3;

S6, casting

adjusting the temperature in the crucible to 745° C. after S5, and keeping the temperature for 20 min; then injecting the alloy melt in the crucible into the copper mold from the bottom of the crucible, with an injection time of 7 s; then immediately applying a pressure of 170 kPa to the copper mold for 3 min, to obtain an aluminum-lithium alloy ingot, and the elastic modulus of the as-cast aluminum-lithium alloy is tested by the pulse excitation method;

S7, heat treatment

placing the aluminum-lithium alloy ingot obtained by a vacuum melting and casting in S6 into an inert gas protected furnace, and performing a three step solution heat treatment, and then quenching the ingot in water immediately; wherein, the three step solution heat treatment comprises: keeping the temperature at 440° C. for 5 h, 480° C. for 4 h, and 510° C. for 5 h, respectively. The ingot is quenched in water immediately after temperature keeping, with a heating rate of 1.5° C./min;

performing an one-stage ageing treatment in a temperature range of 170° C. for 20 h to the ingot subjected to a solid solution in an inert gas protected furnace;

S8, cooling

taking out the ingot subjected to the heat treatment in S7 and cooling in air to obtain the aluminum-lithium alloy with low density, high strength, and high elastic modulus; the metallographic structure of the heat-treated alloy is shown in FIG. 1B, and the elastic modulus of the heat-treated aluminum-lithium alloy is measured by pulse excitation method.

Hereinabove, the inert gas used is argon.

In the above-mentioned S7, the pressure in the furnace is adjusted to below 1 kPa before argon introducing, and the pressure in the furnace reaches 105 kPa by argon introducing, which is repeated 3 times.

The aluminum-lithium alloy with low density, high strength and high elastic modulus has: density of 2.51 g/cm³, tensile strength of 349 MPa, elongation of 5.0%, as-cast elastic modulus of 80.6 GPa, and the heat treatment elastic modulus of 84.3 GPa.

### Embodiment 6

A chemical composition of the aluminum-lithium alloy with low density, high strength, and high elasticity-modulus by weight is: Cu 4.10 wt %, Li 3.80 wt %, Mg 1.87 wt %, Zn 0.92 wt %, Ag 0.72 wt %, Er 0.09 wt %, Zr 0.20 wt %, Fe 0.065 wt %, Si 0.025 wt %, and the balance is Al and inevitable impurities.

A method for preparing the aluminum-lithium alloy with low density, high strength and high elastic modulus comprises the following steps:

S1, preparing raw materials

weighing pure Al, pure Ag, pure Li, Al—Cu master alloy, Al—Mg master alloy, Al—Zn master alloy, Al—Er master alloy and Al—Zr master alloy as raw materials; wherein the purity of pure Al, pure Ag and pure Li is ≥99.9%;

S2, drying

pre-heating pure Al, pure Ag, Al—Cu master alloy, Al—Mg master alloy, Al—Zn master alloy, Al—Er master alloy and Al—Zr master alloy weighed in S1 and a crucible for 1.5 h at 205° C.;

S3, adjusting pressure of an electromagnetic-induction furnace

placing the pre-heated raw materials in S2 into the pre-heated crucible, and placing the pre-heated crucible into the electromagnetic-induction furnace, adjusting the pressure in the electromagnetic-induction furnace to 7 kPa before melting, and then adding argon until the pressure in the furnace reaches 106 kPa, repeating the above steps 2 times, and finally keeping the pressure in the furnace at 111 kPa;

S4, melting in a vacuum induction furnace

increasing the temperature step by step by heating power adjustment to smelt the raw materials of S3 until the aluminum-lithium alloy raw materials are completely melted; wherein, a process of increasing the temperature step by step to smelt comprises: first increasing the temperature of the alloy in the crucible to 340° C. in 4 min, then increasing the temperature in the crucible to 490° C. in 3 min, then increasing the temperature in the crucible to 700° C. in 5 min, and finally increasing the temperature in the crucible to 790° C. in 3 min, until the alloy in the crucible is completely melted;

S5, power adjustment

adjusting the power of the electromagnetic-induction furnace by a program to apply electromagnetic stirring between 10% and 100% for 8 min after melting in S4, and repeating S3;

S6, casting

adjusting the temperature in the crucible to 730° C. after S5, and keeping the temperature for 25 min; then injecting the alloy melt in the crucible into the copper mold from the bottom of the crucible, with an injection time of 10 s; then immediately applying a pressure of 230 kPa to the copper mold for 1 min, to obtain an aluminum-lithium alloy ingot; and the elastic modulus of the as-cast aluminum-lithium alloy is tested by the pulse excitation method;

S7, heat treatment

placing the aluminum-lithium alloy ingot obtained by a vacuum melting and casting in S6 into an inert gas protected furnace, and performing a three step solution heat treatment, and then quenching the ingot in water immediately; wherein, the three step solution heat treatment comprises: keeping the temperature at 450° C. for 5 h, 480° C. for 5 h, and 512° C. for 6 h, respectively. The ingot is quenched in water immediately after temperature keeping, with a heating rate of 1° C./min;

performing an one-stage ageing treatment in a temperature range of 170° C. for 22 h to the ingot subjected to a solid solution in an inert gas protected furnace;

S8, cooling

taking out the ingot subjected to the heat treatment in S7 and cooling in air to obtain the aluminum-lithium alloy with low density, high strength, and high elastic modulus; and the elastic modulus of the heat-treated aluminum-lithium alloy is measured by pulse excitation method.

Hereinabove, the inert gas used is argon.

In the above-mentioned S7, the pressure in the furnace is adjusted to below 1 kPa before argon introducing, and the pressure in the furnace reaches 105 kPa by argon introducing, which is repeated 3 times.

The aluminum-lithium alloy with low density, high strength and high elastic modulus has: density of 2.47 g/cm³, tensile strength of 335 MPa, elongation of 4.1%, as-cast elastic modulus of 82.3 GPa, and the heat treatment elastic modulus of 86.2 GPa.

### Comparative Embodiment 1

A chemical composition of the aluminum-lithium alloy with low density, high strength, and high elastic modulus by weight is: Cu 3.55 wt %, Li 1.40 wt %, Mg 0.73 wt %, Zn 1.04 wt %, Ti 0.20 wt %, Zr 0.14 wt %, Fe 0.09 wt %, Si 0.06 wt %, and the balance is Al and inevitable impurities.

A method for preparing the aluminum-lithium alloy, wherein the preparation method comprises the following steps:

S1, preparing raw materials

weighing pure Al, pure Ag, pure Li, Al—Cu master alloy, Al—Mg master alloy, Al—Zn master alloy, Al—Er master alloy and Al—Zr master alloy as raw materials; wherein the purity of pure Al, pure Ag and pure Li is ≥99.9%;

S2, drying

pre-heating the pure Al, the pure Ag, the Al—Cu master alloy, the Al—Mg master alloy, the Al—Zn master alloy, the Al—Er master alloy and the Al—Zr master alloy weighed in S1 and a crucible for 1.5 h at 205° C.;

S3, adjusting pressure of an electromagnetic-induction furnace placing the pre-heated raw materials in S2 into the pre-heated crucible, and placing the crucible into the electromagnetic-induction furnace, adjusting the pressure in the electromagnetic-induction furnace to 5 kPa before melting, and then adding argon until the pressure in the furnace reaches 105 kPa, repeating the above steps 4 times, and finally keeping the pressure in the furnace at 105 kPa;

S4, melting in a vacuum induction furnace

first increasing the alloy in the crucible in S3 to 800° C. in 10 min by heating power adjustment of the vacuum induction furnace until the alloy is completely melted;

S5, power adjustment

adjusting the power of the electromagnetic-induction furnace by a program to apply electromagnetic stirring between 10% and 100% for 5 min after melting in S4;

S6, casting

adjusting the temperature in the crucible to 730° C. after S5, and keeping the temperature for 30 min; then injecting the alloy melt in the crucible into the copper mold from the bottom of the crucible after temperature keeping, with an injection time of 10 s; to obtain an aluminum-lithium alloy ingot; and the elastic modulus of the as-cast aluminum-lithium alloy is tested by the pulse excitation method;

S7, heat treatment

placing aluminum-lithium alloy ingot in S6 into an inert gas protected furnace, and performing a three step solution heat treatment, and keeping the temperature at 490° C. for 6 h, and then quenching the ingot in water immediately after temperature keeping; preferably, increasing the temperature in the vacuum furnace to the specified temperature with a heating rate of 5° C./min;

performing an one-stage ageing treatment to the ingot subjected to a solid solution in an inert gas protected furnace, and keeping the temperature at 180° C. for 8 h;

S8, cooling

taking out the ingot subjected to the heat treatment in S7 and cooling in air to obtain the aluminum-lithium alloy with low density, high strength, and high elastic modulus; and the elastic modulus of the heat-treated aluminum-lithium alloy is measured by pulse excitation method.

Table 1 below shows the elastic modulus of as-cast and heat-treated aluminum-lithium alloys in Embodiments 1 to 6 and Comparative Embodiment 1.

It can be seen from this Table, after aluminum-lithium alloys in Embodiments 1-6 are prepared by the method of the present application, all the elastic modulus can reach more than 80 GPa after heat treatment. Although there is no significant difference between the elastic modulus of as-cast alloy in Comparative Embodiment 1 and those in Embodiment 1-6, the elastic modulus of the alloy after heat treatment is not increased but decreased, which is much lower than those of the heat-treated alloys in Embodiments 1 to 6. The reason is that during melting process, vacuum-pumping and argon blowing are not used repeatedly, and the pressure treatment is performed after casting, and the three-step solution heat treatment scheme is not used for the heat treatment of the as-cast alloy. It shows that composition of aluminum-lithium alloy used in the present application can be well matched with the designed heat treatment process, and finally the alloy can get a higher elastic modulus.

TABLE 1

| Elastic modulus/GPa | As-cast | Heat treatment state |
|---|---|---|
| Embodiment 1 | 77.6 | 81.6 |
| Embodiment 2 | 77.6 | 81.7 |
| Embodiment 3 | 77.2 | 80.4 |
| Embodiment 4 | 81.6 | 85.4 |
| Embodiment 5 | 80.6 | 84.3 |
| Embodiment 6 | 82.3 | 86.2 |
| Comparative Embodiment 1 | 78.4 | 74.9 |

Hereinabove, a method of vacuum electromagnetic-induction heating and inert gas protection is used in the present application to smelt aluminum-lithium alloy with high lithium content, which avoids lithium oxidation, repeated usage of covering agent and other dangers in the atmospheric environment.

A process of electromagnetic-induction melting is optimized by the present application. The temperature is slowly increased step by step in the heating process, which can accurately control the melting temperature. The molten metal is electromagnetically stirred by controlling the power of the vacuum furnace to apply electromagnetic stirring at a certain frequency, and vacuum-pumping and argon blowing are performed repeatedly to ensure effective removal of harmful impurity elements in aluminum-lithium alloys and avoid excessive burning of alloy elements.

Injecting molten metal from the bottom of the crucible can effectively remove the enriched oxide inclusions on upper surface of the crucible; at the same time, by pressurizing the melt after casting, defects, for example holes and shrinkage inside the aluminum-lithium alloy ingot can be significantly reduced, which can significantly improve the elastic modulus of as-cast alloy.

The present application may further improve elastic modulus of the alloy relative to the traditional as-cast aluminum-lithium alloy ingot by means of the three step solution heat treatment and the one-stage aging treatment, and finally an aluminum-lithium alloy ingot with high elastic modulus which is not available in the prior art is obtained.

The price of Er added to the aluminum-lithium alloy ingot with high elastic modulus in the present application is $26.4/kg, which is two orders of magnitude lower than that of the traditional Sc of $3460/kg, and the process is also simple, which is beneficial to large-scale industrial production.

The as-cast structure of the aluminum-lithium alloy with low density, high strength and high elastic modulus in the present application is a face-centered cubic aluminum matrix and an intermetallic compound of Al₂CuMg, Al₆CuLi₃, Al₇Cu₄Li, AlLi that has coarse grains at grain boundaries, and a heat treatment state structure is the face-centered cubic aluminum matrix and a nano-sized precipitated phase of Al₂CuLi, Al₃Li, Al₂CuMg that is uniformly distributed and has tiny grains, and the intermetallic compound at the grain boundaries is significantly smaller than the as-cast structure in size.

The aluminum-lithium alloy with low density, high strength and high elastic modulus in the present application has: a density of 2.47-2.69 g/cm³, a tensile strength of 230-350 MPa, an elongation of 2.0-8.0%, an as-cast elastic modulus of 77-83 GPa, and a heat-treatment-state elastic modulus of 80-86 GPa.

In conclusion, the present application relates to the aluminum-lithium alloy with Cu 1.5-4.5 wt % and Li 2.4-3.8 wt % of the present application, which is much higher than that of all previously reported contents of Cu and Li. The vacuum melting and inert gas protection are used, in order to eliminate the harmful elements such as H, Na, K and the like in the aluminum lithium alloy, and the alloy elements in the cast ingot are controlled within a specified range. The process of producing alloy ingot is simpler than that under the protection of covering agent. Combined with a specific heat treatment process, the elastic modulus of the cast aluminum-lithium alloy can be significantly improved, which is the basis for the subsequent preparation and processing of high-elastic-modulus deformable parts of the aluminum-lithium alloy, and can be widely applied in the aerospace field.

The above are the preferred embodiments of the present application. It should be understood that for those skilled in the art, several improvements and modifications can be made, without departing from the principles of the present application. These improvements and modifications should also be regarded as the protection scope of the present application.

What is claimed is:

1. An aluminum-lithium alloy with low density, high strength, and high elastic modulus, wherein a chemical composition of the aluminum-lithium alloy with low density, high strength, and high elastic modulus by weight percentage is: Cu 1.5-4.5 wt. %, Li 2.4-3.8 wt. %, Mg 0.5-2.0 wt. %, Zn 0.5-1.0 wt. %, Ag 0.3-0.8 wt. %, Er 0.05-0.3 wt. %, Zr 0.05-0.25 wt. %, Fe≤0.08 wt. %, Si≤0.05 wt. %, the balance being Al and inevitable impurities.

2. The aluminum-lithium alloy with low density, high strength, and high elastic modulus according to claim 1, wherein an as-cast structure of the aluminum-lithium alloy with low density, high strength, and high elastic modulus is a face-centered cubic aluminum matrix and an intermetallic compound of Al₂CuMg, Al₆CuLi₃, Al₇Cu₄Li, and AlLi within coarse grains and distributed at grain boundaries, a heat treatment state structure of the aluminum-lithium alloy with low density, high strength, and high elastic modulus is the face-centered cubic aluminum matrix and nano-sized precipitates of Al₂CuLi, Al₃Li, and Al₂CuMg within grains uniformly, and the intermetallic compound at the grain boundaries is significantly smaller than the as-cast structure in size.

3. The aluminum-lithium alloy with low density, high strength, and high elastic modulus according to claim 1, wherein the aluminum-lithium alloy with low density, high strength, and high elastic modulus has the following properties: a density of 2.47-2.69 g/cm³, a tensile strength of 230-350 MPa, an elongation of 2.0-8.0%, an as-cast elastic modulus of 77-83 GPa, and a heat-treatment-state elastic modulus of 80-86 GPa.

4. A method for preparing the aluminum-lithium alloy with low density, high strength, and high elastic modulus according to claim 1, comprising the following steps:
S1, preparing raw materials
weighing pure Al, pure Ag, pure Li, a Al—Cu master alloy, a Al—Mg master alloy, a Al—Zn master alloy, a Al—Er master alloy, and a Al—Zr master alloy as raw materials based on the chemical composition by weight percentage of the aluminum-lithium alloy with low density, high strength, and high elastic modulus;
S2, drying
pre-heating the pure Al, the pure Ag, the Al—Cu master alloy, the Al—Mg master alloy, the Al—Zn master alloy, the Al—Er master alloy, and the Al—Zr master alloy weighed in S1 and a crucible for 0.5-2 h at 200-220° C.;
S3, adjusting a pressure of an electromagnetic-induction furnace
placing the raw materials pre-heated in S2 into the crucible pre-heated, and then placing the crucible into the electromagnetic-induction furnace, adjusting the pressure in the electromagnetic-induction furnace to 5-10 kPa before melting, and then adding argon until the pressure in the electromagnetic-induction furnace reaches 100-110 kPa, repeating the above steps 2-4 times, and finally keeping the pressure in the electromagnetic-induction furnace at 105-115 kPa;
S4, melting in a vacuum induction furnace
increasing a temperature step by step by a heating power adjustment to smelt the raw materials of S3 until the aluminum-lithium alloy raw materials are completely melted;
S5, power adjustment
adjusting a power of the electromagnetic-induction furnace with a program to apply an electromagnetic stirring between 10% and 100% for 5-10 min after melting in S4, and repeating a pressure adjustment step in S3;
S6, casting
adjusting the temperature in the crucible after S5 and keeping the temperature; injecting an alloy melt in the crucible into a copper mold from a bottom of the crucible, and immediately applying a pressure of 150-250 kPa to the copper mold for 1-3 min to obtain an aluminum-lithium alloy ingot;
S7, heat treatment
placing the aluminum-lithium alloy ingot obtained by vacuum melting and casting in S6 into an inert gas protected furnace, and performing a three step solution heat treatment, and then quenching the aluminum-lithium alloy ingot in water immediately after an end of the three-step solution heat treatment;
performing an one-stage ageing treatment to the aluminum-lithium alloy ingot subjected to the three step solution heat treatment in the inert gas protected furnace;
S8, cooling
taking out the aluminum-lithium alloy ingot subjected to the heat treatment in S7 and cooling in air to obtain the aluminum-lithium alloy with low density, high strength, and high elastic modulus.

5. The method for preparing the aluminum-lithium alloy with low density, high strength, and high elastic modulus according to claim 4, wherein the crucible in S3 is a steel crucible specially coated with boron nitride.

6. The method for preparing the aluminum-lithium alloy with low density, high strength, and high elastic modulus according to claim 4, wherein a process of increasing the temperature step by step to smelt in S4 comprises:
first increasing the temperature of the alloy in the crucible to 300-350° C. within 2-5 min, then increasing the temperature of the crucible to 450-500° C. within 2-3 min, then increasing the temperature of the crucible to 650-700° C. within 3-5 min, and finally increasing the temperature of the crucible to 750-800° C. within 2-3 min.

7. The method for preparing the aluminum-lithium alloy with low density, high strength, and high elastic modulus according to claim 4, wherein the alloy melt in step S6 is injected into the copper mold within 5-10 s.

8. The method for preparing the aluminum-lithium alloy with low density, high strength, and high elastic modulus according to claim 4, wherein the three step solution heat treatment in S7 comprises:
keeping the temperature at 430-450° C. for 4-6 h, 470-490° C. for 4-6 h, and 500-520° C. for 4-6 h, respectively;
quenching the aluminum-lithium alloy ingot in the water immediately after temperature keeping, with a heating rate of 1-2° C./min.

9. The method for preparing the aluminum-lithium alloy with low density, high strength, and high elastic modulus according to claim 4, wherein the one-stage ageing treatment in S7 comprises: keeping the temperature for 6-24 h at a temperature range of 160-200° C.

10. The method for preparing the aluminum-lithium alloy with low density, high strength, and high elastic modulus according to claim 4, wherein an inert gas in S7 is argon, adjusting a pressure in the inert gas protected furnace to less than 1 kPa before the argon is introduced into the inert gas protected furnace, and adjusting the pressure in the inert gas protected furnace to 100-105 kPa by introducing the argon, and repeating for 1-3 times.

11. The method for preparing the aluminum-lithium alloy with low density, high strength, and high elastic modulus according to claim 4, wherein an as-cast structure of the aluminum-lithium alloy with low density, high strength, and high elastic modulus is a face-centered cubic aluminum matrix and an intermetallic compound of Al₂CuMg, Al₆CuLi₃, Al₇Cu₄Li, and AlLi within coarse grains and distributed at grain boundaries, a heat treatment state structure of the aluminum-lithium alloy with low density, high strength, and high elastic modulus is the face-centered cubic aluminum matrix and nano-sized precipitates of Al₂CuLi, Al₃Li, and Al₂CuMg within grains uniformly, and the intermetallic compounds at the grain boundaries is significantly smaller than the as-cast structure in size.

12. The method for preparing the aluminum-lithium alloy with low density, high strength, and high elastic modulus according to claim 4, wherein the aluminum-lithium alloy with low density, high strength, and high elastic modulus has the following properties: a density of 2.47-2.69 g/cm³, a tensile strength of 230-350 MPa, an elongation of 2.0-8.0%, an as-cast elastic modulus of 77-83 GPa, and a heat-treatment-state elastic modulus of 80-86 GPa.
